(19) United States
(12) Patent Application Publication
(10) Pub. No.: US 2026/0192726 A1
(43) Pub. Date: Jul. 9, 2026

(54) DOORLESS SLAG TRANSPORT DEVICE, SYSTEM, AND METHOD

(71) Applicant: PALING TRANSPORTER LTD., Hamilton (CA)

(72) Inventor: Bogdan CHARCZUK, Winona (CA)

(21) Appl. No.: 19/444,870

(22) Filed: Jan. 9, 2026

Related U.S. Application Data
(60) Provisional application No. 63/743,525, filed on Jan. 9, 2025.

(51) Int. Cl. B60P 1/28

(52) U.S. Cl. CPC B60P 1/283

(57) ABSTRACT

A doorless slag transport device, system, and method integrate an elongate dump container and a pallet for use with a transport carrier. The dump container is for receiving molten slag. It has a container bottom, and a dump end with an inclined spout that is doorless and enables controlled discharge of the slag from the container. The pallet has a pallet end with hinges that securely engage the dump end and enable pivotal rotation of the container. The transport carrier securely and detachably engages the pallet. The transport carrier has telescoping arms that securely and detachably engage the container bottom. The telescoping arms are selectively controllable to pivot the container about the hinges between transport and dumping configurations. In the dumping configuration, the container, free of any door mechanism, discharges the molten slag through the spout. The invention helps impede formation of a slag skull in the dump container.

### FIELD OF THE INVENTION

The present invention relates generally to slag transport systems and, more particularly, to a doorless slag transport device, system, and/or method.

### BACKGROUND OF THE INVENTION

Slag is a by-product of metallurgical smelting processes. In the prior art, the most common means of collecting and transporting slag may have been through use of a slag pot and associated carrier. Other common practices may have included dumping slag directly onto the ground and removing it through use of a front loading loader.

Problems or shortcomings associated with the prior art may have included one or more of the following:
CAPACITY RESTRICTIONS. In the prior art, many slag pot users may have outgrown the capacities afforded by prior art slag pots. Prior art slag pots may have been limited, by design, in the height of the slag pot and/or in its diameter. Any such limitations may have made it difficult to accommodate a bigger pot in existing facilities.
SLAG PROCESSING. From the prior art, slag pots may have been known to create a hard shell of cold slag and steel called a “skull”. (The skull may have been a large, solid piece of mainly metal oxides and/or silicon dioxide that may be ferrous, a ferroalloy, or non-ferrous.) Dealing with the skull also may have been a significant part of slag processing and/or among the most labour-intensive/environmentally unfriendly operations in steel production. Removing slag from a prior art pot carrier may have required (a) dumping of fluid, molten slag, (b) transferring the slag pot to a “knocking stage”, wherein the pot may have been turned upside-down and/or repeatedly struck against a surface to get the skull loose/removed from how it otherwise may have stuck to the pot, and/or (c) lancing the skull into smaller pieces after it has cooled, such as to enable to further processing/recycling.
POT MAINTENANCE/LIFE EXPECTANCY. Perhaps due to the design and/or working cycle of prior art slag pots, they may have a relatively short working life and/or repairing them may have been costly. For the most part, time-worn out prior art slag pots may have been scrapped. Prior art slag pots may have been constructed from one or more cast iron materials.
SAFETY. Prior art slag pot carriers may have had their hydraulic components closed-off from the pot. Prior art pots catching on fire may have been a well-known problem due, perhaps at least in part, to the shape and design of such pots. Explosions of trapped gases may have been relatively common. In the prior art, slag may have been removed by front end loaders, potentially exposing operators directly to the molten slag.
EQUIPMENT. Prior art slag pots may have required dedicated pieces of carrier equipment to move them around steel plants. Such carriers may have tended to be too wide to fit under existing furnaces. And/or,
ENVIRONMENTAL IMPACT. Oxygen, and/or thermal lancing, may have been required to break-down skulls (created using prior art slag pots) into manageable pieces. This prior art practice may have created large clouds of debris.

What may be needed is a high-capacity, self-cleaning, and/or doorless slag carrier container for the steel industry. Such a container design may preferably enable steel-makers to collect and/or transport high volumes of slag, preferably without interruption, and/or preferably while maintaining a safe operation and/or considering environmental impact, equipment flexibility, and/or low operating cost. What may be needed is a device, system, and/or method that helps reduce or eliminate slag skulls.

It may be an object of the invention to provide a doorless slag transport device, system, and/or method. Such a device may preferably be constructed from one or more high-strength, fine-grained structural steel materials, and/or from one or more thermo-mechanically rolled structural steel materials, which may preferably enable use in high-temperature applications.

It may be an object according to an aspect of the invention to provide a doorless slag transport device, system, and/or method that integrates and/or involves a cold-formed and/or welded steel construction, which may preferably mount to a base frame/pallet.

It may be an object according to an aspect of the invention to provide a doorless slag transport device, system, and/or method that (a) is high capacity and/or accommodates a high volume capacity, (b) is flexible and/or enables use in association with a variety of different volumes and/or space restrictions, (c) helps to prevent and/or reduce creation of hard shell “skulls”, (d) helps to make slag processing more safe and/or environmentally friendly, (e) is protected against thermal shock, has high strength and/or durability, and/or is capable of withstanding temperatures and/or cycles required by steel plants without significant wear and/or permanent deformation, (f) enables removal of hydraulic lines close to the container, preferably while maintaining a full slag discharge and/or self-cleaning capability, and/or (g) doesn't require dedicated equipment and/or can be moved by the same equipment/power unit that is used to move other types of material (e.g., coil pallets, scrap pallets, slabs pallets, and others) within a steel plant.

It may be an object according to an aspect of the invention to provide a doorless slag transport device and/or system that may preferably but need not necessarily have an adjustable midsection that enables variation of carrying capacity.

It is an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a doorless slag transport system, for use with molten slag in the steel industry. The system may preferably include an elongate dump container, a pallet unit, and/or a transport carrier unit. The dump container may preferably be adapted to receive the molten slag, and preferably has a container bottom portion and/or a dump end portion with an inclined spout portion that is preferably doorless and/or enables controlled discharge of the molten slag from the dump container. The pallet unit may preferably have a pallet end portion with one or more hinge mechanisms that preferably securely engage the dump end portion and/or enable pivotal rotation of the dump container, preferably about the hinge mechanisms, relative to the pallet unit. Preferably, the transport carrier unit securely and/or detachably engages the pallet unit. The transport carrier unit may preferably have one or more telescoping arms that securely and/or detachably engage the container bottom portion. The telescoping arms may preferably be selectively controllable to pivot the dump container about the hinge mechanisms, relative to the pallet unit, between a transport configuration and a dumping configuration. Preferably in the dumping configuration the dump container, preferably free of any door mechanism, may preferably discharge the molten slag through the inclined spout portion.

According to an aspect of the invention, the dump container may preferably, but need not necessarily, be shallow, wide, and/or otherwise adapted to impede formation of a slag skull by the molten slag received therewithin, and/or to enable the molten slag to cool in sheet form. The container bottom portion may preferably, but need not necessarily, be inclined. Preferably in the dumping configuration, the container bottom portion and/or the inclined spout portion may preferably, but need not necessarily, enable substantially complete discharge of the molten slag, preferably in the aforesaid sheet form, from the dump container.

According to an aspect of the invention, the inclined spout portion may preferably, but need not necessarily, have a spout angle, preferably relative to the bottom portion, that is substantially about 57 degrees.

According to an aspect of the invention, preferably in the dumping configuration, the dump container may preferably, but need not necessarily, be raised and/or pivoted to a dump angle, preferably relative to the pallet unit, that is substantially between about 45 and 57 degrees.

According to an aspect of the invention, the pallet end portion may preferably, but need not necessarily, have one or more safety stops that securely engage the container bottom portion and/or prevent the dump container from being pivoted beyond the dumping configuration.

According to an aspect of the invention, the dump container may preferably, but need not necessarily, be constructed from one or more structural steel materials. The structural steel materials of the dump container may preferably, but need not necessarily, be substantially about 80 mm thick with a yield strength of at least about 420 MPa.

According to an aspect of the invention, the dump container may preferably, but need not necessarily, be configured for heat dissipation such that, preferably when the dump container receives a volume of the molten slag that is substantially about 20 m³, the molten slag may preferably, but need not necessarily, have an exposed surface area of substantially about 30 m².

According to an aspect of the invention, the dump container may preferably, but need not necessarily, have opposing side walls. Each of the side walls may preferably, but need not necessarily, meet the container bottom portion at a side wall angle of substantially about 112 degrees.

According to an aspect of the invention, the container bottom portion may preferably, but need not necessarily, be shaped to define one or more arm receptacles. The telescoping arms may preferably, but need not necessarily, securely and/or detachably engage the arm receptacles.

According to an aspect of the invention, the pallet unit may preferably, but need not necessarily, be shaped to define pin receptacles. The transport carrier unit may preferably, but need not necessarily, have horizontal locking pins that removably extend into the pin receptacles, preferably for secure locking of the pallet unit to the transport carrier unit. The horizontal locking pins may preferably, but need not necessarily, be selectively disengageable from the pin receptacles, preferably to detach the pallet unit from the transport carrier unit.

According to an aspect of the invention, the dump container may preferably, but need not necessarily, be constructed with a predetermined capacity to receive between about 20 and 70 m³ of the molten slag.

According to an aspect of the invention, the dump container may preferably, but need not necessarily, have a front end portion opposite the dump end portion, and/or one or more mid-sections. The mid-sections may preferably, but need not necessarily, be secured between the front end portion and the dump end portion. The front end portion, the mid-sections, and/or the dump end portion may preferably, but need not necessarily, have a cold formed and/or welded steel construction. The predetermined capacity may preferably, but need not necessarily, be selectively adjustable by varying how many of the mid-sections are preferably secured between the front end portion and the dump end portion.

According to an aspect of the invention, the transport carrier unit may preferably, but need not necessarily, selectively lift the pallet unit for transport, and/or selectively lower the pallet unit for pivoting the dump container about the hinge mechanisms.

According to an aspect of the invention, the transport carrier unit may preferably, but need not necessarily, have a cab for a user. The dump container may preferably, but need not necessarily, have a front canopy, preferably opposite the dump end portion, that may preferably protect the cab against splashes of the molten slag for the user.

According to the invention, there is also disclosed a doorless slag dumping device, preferably for use with molten slag and/or a transport carrier unit having one or more telescoping arms. The doorless slag dumping device may preferably include an elongate dump container and/or a pallet unit. The dump container may preferably be adapted to receive the molten slag, and/or to have a container bottom portion and/or a dump end portion with an inclined spout portion. The inclined spout portion may preferably be doorless and/or enable controlled discharge of the molten slag from the dump container. Preferably, the telescoping arms securely and/or detachably engage the container bottom portion. The pallet unit may preferably be for secure and/or detachable engagement with the transport carrier unit. The pallet unit may preferably have a pallet end portion with one or more hinge mechanisms. Preferably, the hinge mechanisms securely engage the dump end portion and/or enable pivotal rotation of the dump container, preferably about the hinge mechanisms, relative to the pallet unit. The telescoping arms may preferably be selectively controllable to pivot the dump container about the hinge mechanisms, relative to the pallet unit, between a transport configuration and a dumping configuration. Preferably in the dumping configuration, the dump container, preferably free of any door mechanism, may preferably discharge the molten slag through the inclined spout portion.

According to the invention, there is also disclosed a method for use with the system described above. The method may preferably include steps (a) and/or (b). Preferably in step (a), molten slag may preferably be received in the dump container. Preferably in step (b), the telescoping arms of the transport carrier unit may preferably be controlled to pivot the dump container about the hinge mechanisms, relative to the pallet unit, from the transport configuration to the dumping configuration. Preferably as such the dump container, preferably free of any door mechanism, may then preferably discharge the molten slag through the inclined spout portion.

According to an aspect of the invention, preferably in step (a), the dump container may preferably, but need not necessarily, be shallow and/or wide, and/or impede formation of a slag skull by the molten slag received therewithin. The container bottom portion may preferably, but need not necessarily, be inclined and/or enable the molten slag to cool in sheet form. Preferably in step (b), in the dumping configuration, the container bottom portion and/or the inclined spout portion may preferably, but need not necessarily, enable substantially complete discharge of the molten slag, preferably in the aforesaid sheet form, from the dump container.

According to an aspect of the invention, preferably in step (b), the dump container may preferably, but need not necessarily, be raised and/or pivoted to a dump angle, preferably relative to the pallet unit, that may preferably be substantially between about 45 and 57 degrees.

According to an aspect of the invention, the method may preferably, but need not necessarily, also include a step of using the transport carrier unit to selectively lift the pallet unit for transport, and/or selectively lower the pallet unit for pivoting the dump container about the hinge mechanisms.

According to an aspect of the invention, the method may preferably, but need not necessarily, also include a step, preferably before step (a), of constructing the dump container with a predetermined capacity for receiving between about 20 and 70 m³ of the molten slag. The dump container may preferably, but need not necessarily, be constructed with a front end portion opposite the dump end portion, and/or with one or more mid-sections secured between the front end portion and the dump end portion. The front end portion, the mid-sections, and/or the dump end portion may preferably, but need not necessarily, have a cold formed and/or welded steel construction. The predetermined capacity may preferably, but need not necessarily, be selectively adjustable by varying how many of the mid-sections may preferably be secured between the front end portion and the dump end portion.

By way of a further and/or alternate summary, according to the invention, there is disclosed a doorless slag transport device, system, and method. The doorless slag transport device, system, and method preferably involve or integrate a high-capacity, self-cleaning, doorless slag carrier container for the steel industry. This container design preferably enables steel-makers to collect and transport high volumes of slag, preferably without interruption, and preferably while maintaining a safe operation, lessened environmental impact, equipment flexibility, and low operating cost. The doorless slag transport device, system, and method according to the invention preferably help to reduce or eliminate slag skulls.

According to an aspect of the invention, the doorless slag transport device, system, and/or method may preferably, but need not necessarily, accommodate a high volume capacity. This high volume capacity may preferably, but need not necessarily, be achieved by increasing a footprint (e.g., instead of the height) of the slag transport device, and/or by utilizing an elongated vessel. The slag transport device may preferably, but need not necessarily, be flexible and/or modifiable to accommodate any volume and/or space restriction.

According to an aspect of the invention, the doorless slag transport device, system, and/or method may preferably, but need not necessarily, involve or integrate a slag discharge feature that enables, causes, and/or helps the slag to break down as it is discharged due to a unique shaping. This feature may preferably, but need not necessarily, help to reduce and/or prevent creation of hard shell “skulls” and/or help to reduce and/or eliminate an expensive, environmentally unfriendly, and/or unsafe process in slag processing.

According to an aspect of the invention, the doorless slag transport device, system, and/or method may preferably, but need not necessarily, involve or integrate a design and/or one or more materials capable of withstanding temperatures and/or cycles required by steel plants without wear and/or permanent deformation. The dump container of the slag transport device, system, and/or method may preferably, but need not necessarily, be resistant and/or impervious to thermal shock, preferably due to its larger surface area. Strength and/or durability of this container may preferably be 5× that of cast steel pots.

According to an aspect of the invention, the slag transport device, system, and/or method may preferably, but need not necessarily, involve or integrate a doorless design. The doorless design may preferably, but need not necessarily, enable removal of any hydraulic line close to the container, preferably while maintaining a full slag discharge and/or self-cleaning capability.

According to an aspect of the invention, the doorless slag transport device, system, and/or method may preferably, but need not necessarily, involve or integrate a single power unit and existing equipment—without requiring any dedicated equipment—which can be used to move other types of material (e.g., coil pallets, scrap pallets, slabs pallets, and others).

To put it another way, according to the invention, there is additionally disclosed a doorless slag transport device, system, and/or method for use in the steel industry. Preferably, the device, system, and/or method may preferably, but need not necessarily, include a carrier unit. The carrier unit may preferably, but need not necessarily, be engine-driven. The carrier unit and/or its engine drive may preferably, but need not necessarily, be continually operating during loading and/or dropping-off phases of a slag transportation process.

According to an aspect of the invention, the carrier unit may preferably, but need not necessarily, be operated from a cab at the front of the carrier unit.

According to an aspect of the invention, the sides of the carrier unit may preferably, but need not necessarily, include horizontal locking pins which preferably extend horizontally outwards from the carrier unit.

According to an aspect of the invention, the carrier unit may preferably, but need not necessarily, have an elongate rear bed. The elongate rear bed may preferably, but need not necessarily, enable interaction with a pallet device. The elongated rear bed may preferably, but need not necessarily, have a bed length of greater than about 10 meters. More preferably, the bed length may be about 12.2 meters.

According to an aspect of the invention, the rear bed may preferably, but need not necessarily, have one or more cylindrical telescoping arms. More preferably, there may be two said cylindrical telescoping arms. The cylindrical telescoping arms may preferably, but need not necessarily, raise and/or lower free from the carrier unit.

According to an aspect of the invention, the rear bed may preferably, but need not necessarily, sit behind the cab of the carrier unit.

According to an aspect of the invention, the device, system, and/or method may preferably, but need not necessarily, involve, integrate, or include a pallet unit. The pallet unit may preferably, but need not necessarily, securely attach to the carrier unit. The pallet unit may preferably, but need not necessarily, engage the horizontal locking pins of the carrier unit. Such engagement may preferably, but need not necessarily, securely lock the pallet unit onto the carrier unit.

According to an aspect of the invention, the device, system, and/or method may preferably, but need not necessarily, involve, integrate, or include a dump container. The dump container may preferably, but need not necessarily, be free of any mechanical and/or hydraulic mechanisms itself.

According to an aspect of the invention, the dump container may preferably, but need not necessarily, securely engage the pallet unit by way of two hinge mechanisms located adjacent to a back portion of the rear bed, opposite the cab. The two hinge mechanisms may preferably, but need not necessarily, keep the dump container securely engaged with the pallet unit when the cylindrical telescoping arms extend from the rear bed to raise the pallet unit.

According to an aspect of the invention, the cylindrical telescoping arms may preferably, but need not necessarily, engage the dump container through two cylindrical receptacles located in the bottom of the dump container. The cylindrical telescoping arms may preferably, but need not necessarily, raise and/or lower the dump container free from the pallet unit. Raising and/or lowering of the cylindrical telescoping arms the cylindrical telescoping arms may preferably, but need not necessarily, occur during a slag dumping process.

According to an aspect of the invention, the device, system, and/or method may preferably, but need not necessarily, involve, integrate, or include one or more safety stops at the back of the pallet unit. The safety stops may preferably, but need not necessarily, prevent the dump container from becoming over-extended during the slag dumping process.

According to an aspect of the invention, the device, system, and/or method may preferably, but need not necessarily, (a) be high capacity and/or accommodate a high volume capacity, (b) be flexible and/or enable use in association with a variety of different volumes and/or space restrictions, (c) help to prevent and/or to reduce creation of hard shell “skulls”, (d) help to make slag processing more safe and/or environmentally friendly, (e) be protected against thermal shock, have high strength and/or durability, and/or be capable of withstanding temperatures and/or cycles required by steel plants without significant wear and/or permanent deformation, (f) enable removal of hydraulic lines close to the container, preferably while maintaining a full slag discharge and/or self-cleaning capability, and/or (g) require no dedicated equipment and/or enable movement by the same equipment/power unit that is used to move other types of material (e.g., coil pallets, scrap pallets, slabs pallets, and others) within a steel plant.

According to an aspect of the invention, the device, system, and/or method may preferably, but need not necessarily, (i) have an increased and/or modifiable carrying capacity which may accommodate higher volumes of slag than in the prior art, (ii) help to reduce and/or eliminate accumulation of skull, preferably, due to a unique shaping of its dump container, (iii) help to prolong a life expectancy of one or more slag transport devices, (iv) help to reduce maintenance that might otherwise be required to keep the slag transport devices operational, (v) help to increase safety for a user of the device, system, and/or method in use, (vi) help to reduce and/or obviate one or more prior art requirements for dedicated or unique equipment, and/or enable more universal application/use of the device, system, and/or method according to the invention, and/or (vii) help to reduce an environmental impact which may otherwise be associated with slag transport devices, systems, and/or methods.

According to an aspect of the invention, the slag transport device, system, and/or method may preferably, but need not necessarily, involve, integrate, or include a novel shape. This shape may preferably, but need not necessarily, help to increase freeboard and/or to lessen a potential for spillage during transport.

According to an aspect of the invention, the doorless slag transport device, system, and/or method may preferably, but need not necessarily, involve, integrate, or include a spout portion. The spout portion may preferably, but need not necessarily, help enable prompt and/or efficient dumping of slag.

According to an aspect of the invention, the slag transport device, system, and/or method may preferably, but need not necessarily, involve, integrate, or include a canopy portion. The canopy portion may preferably, but need not necessarily, provide a measure of splash protection over the cab for the operator.

According to an aspect of the invention, the carrier unit may preferably, but need not necessarily, help install the pallet unit via the horizontal locking pins. The device, system, and/or method may preferably, but need not necessarily, enable secure engagement via the hinge mechanisms at the back of the pallet unit. The device, system, and/or method may preferably, but need not necessarily, enable hinging—free of the pallet unit—when the cylindrical telescoping arms are extended and/or retracted.

According to an aspect of the invention, the dump container may preferably, but need not necessarily, have a cross-sectional shape which helps maximize, increase, or optimize dissipation of heat from hot slag, and/or has an increased available surface area, relative to the prior art.

Persons skilled in the art will appreciate, in view of the teachings and disclosures herein, that the doorless slag transport device, system, and/or method according to the invention offers significant advantageous utilities and/or functionality in comparison to the prior art.

Other advantages, features, and/or characteristics of the present invention, as well as methods of operation and functions of the related elements of the structure, operation, and/or the combination of parts, features, and/or economies of manufacture, will become more apparent upon consideration of the detailed description with reference to the figures which accompany this application.

### BRIEF DESCRIPTION OF THE DRAWINGS

The novel features which are believed to be characteristic of the present invention, and related devices, systems, and/or methods according to the present invention, as to their structure, organization, use, and/or methods of manufacture and/or operation, together with further objectives and advantages thereof, may be better understood from the figures which accompany this application, in which presently preferred embodiments of the invention are illustrated by way of example. It is expressly understood, however, that such figures are provided for the purpose of illustration and/or description only, and not intended as a definition of the limits of the invention. In the accompanying drawings:

FIG. 1 is a front top left perspective view of a carrier unit for a slag transport system according to a preferred embodiment of the invention;

FIG. 2 is a top plan view of the carrier unit of FIG. 1;

FIG. 3 is a front elevational view of the carrier unit of FIG. 1;

FIG. 4 is a left side elevational view of the carrier unit of FIG. 1;

FIG. 5 is a rear elevational view of a headset component of the carrier unit of FIG. 1;

FIG. 6 is a front top left perspective view of a slag dumping device, for use in the slag transport system according to the preferred embodiment of the invention, shown in use with a first volume of slag;

FIG. 7 is a front elevational view of the slag dumping device of FIG. 6;

FIG. 8 is a top plan view of the slag dumping device of FIG. 6, shown in use with a second volume of slag;

FIG. 9 is a left side elevational view of the slag dumping device of FIG. 6;

FIG. 10 is a front top left perspective view of the carrier unit of FIG. 1 together with the slag dumping device of FIG. 6, according to the preferred embodiment of invention, shown in use with the first volume of slag;

FIG. 11 is a front elevational view of the carrier unit and slag dumping device of FIG. 10, shown in a transport configuration;

FIG. 12 is a top plan view of the carrier unit and slag dumping device of FIG. 10;

FIG. 13 is a left side elevational view of the carrier unit and slag dumping device of FIG. 10, shown in the transport configuration;

FIG. 14 is a left side elevational view of the carrier unit and slag dumping device of FIG. 10, shown in a dumping configuration;

FIG. 15 is a rear elevational view, in partial cross-section, of the slag dumping device of FIG. 10, shown in use with the first volume of slag;

FIG. 16 is a left side elevational view of a dump end portion of the slag dumping device of FIG. 6;

FIG. 17 is a rear top right perspective view of the carrier unit and slag dumping device of FIG. 10, shown in use with the first volume of slag;

FIG. 18 is a rear elevational view of the carrier unit and slag dumping device of FIG. 10, shown in the dumping configuration; and

FIG. 19 is a left side elevational view of the carrier unit and slag dumping device of FIG. 10, shown in a partially raised configuration.

### DETAILED DESCRIPTION OF PREFERRED EMBODIMENTS

This disclosure, including the accompanying figures, may include or reference one or more dimensions, numbers, materials of construction, words, phrases, sentences, arrangements, and/or configurations which may be included by way of example. It may bear repeating, in this respect specifically, that such figures and/or any such aspects of this disclosure are for the purpose of illustration and description only, and not intended as a definition of the limits of the invention.

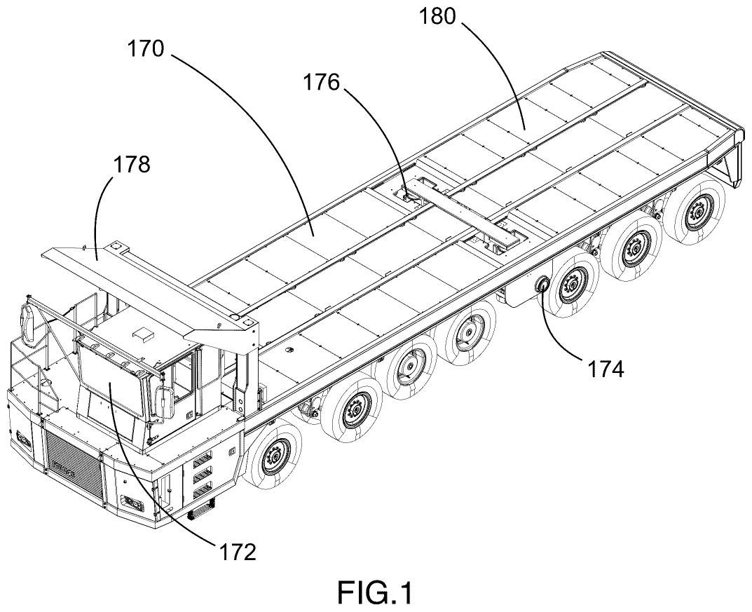

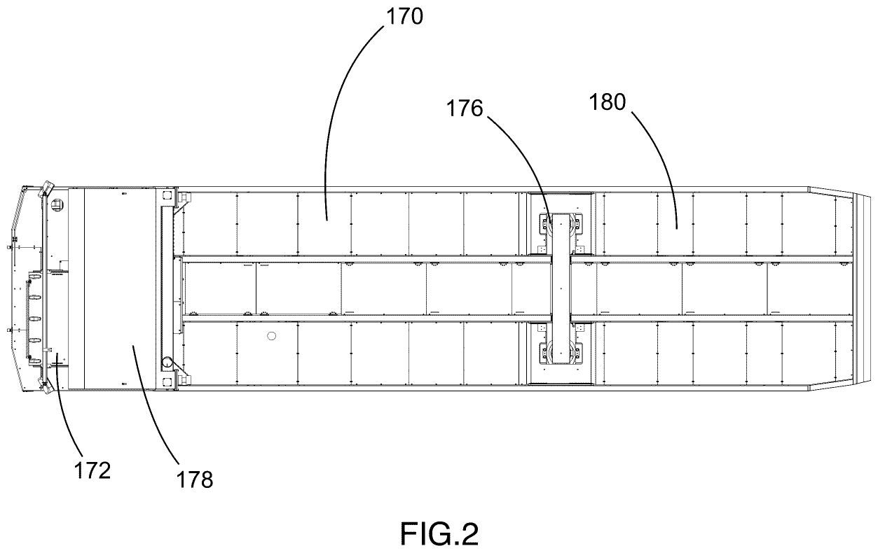

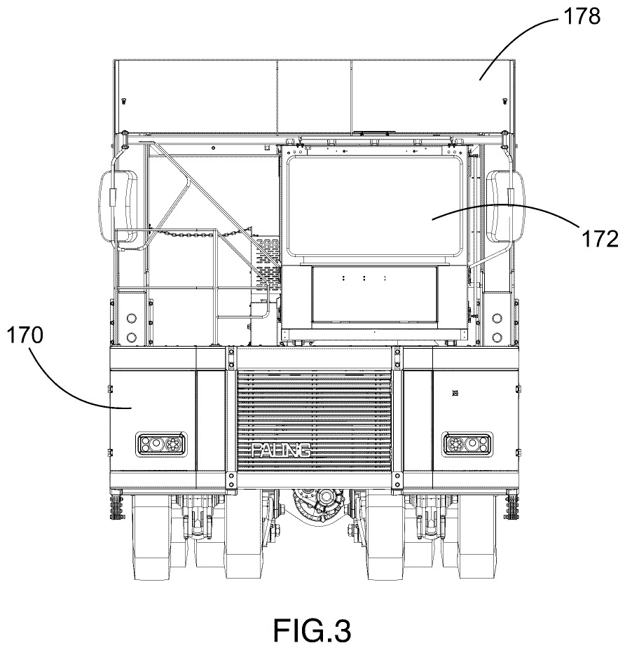

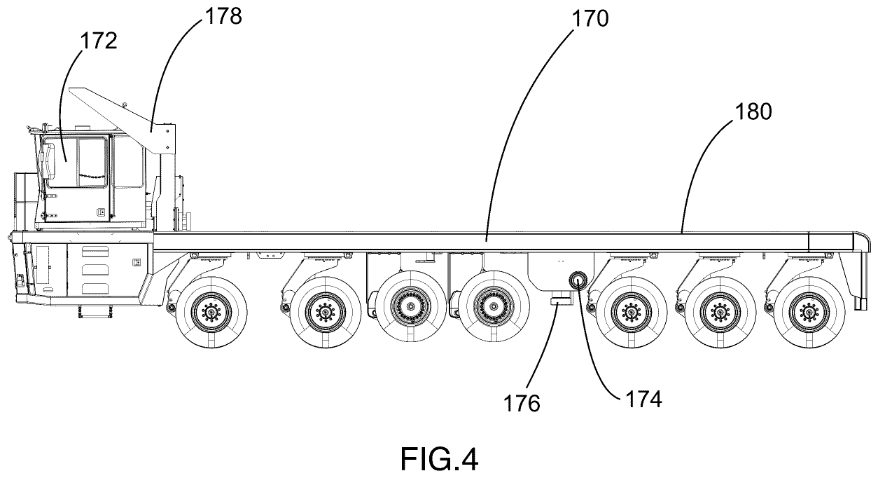

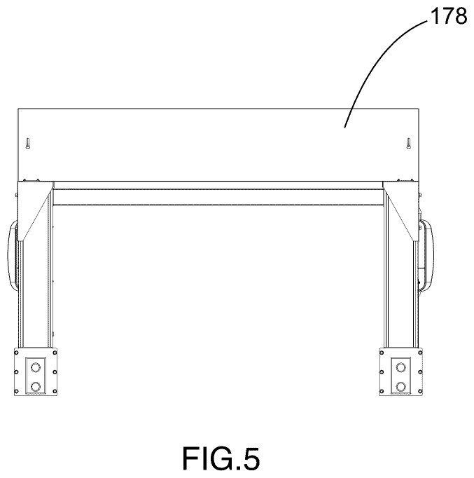

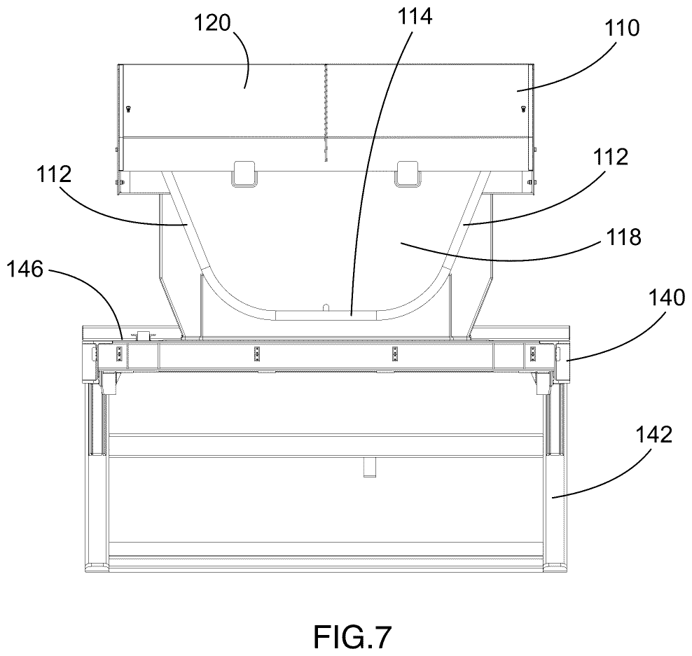

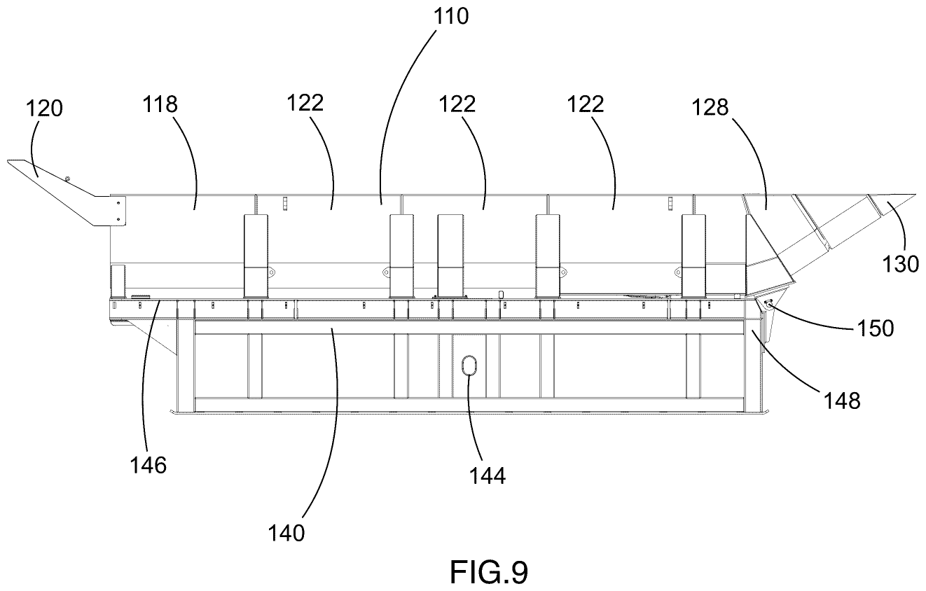

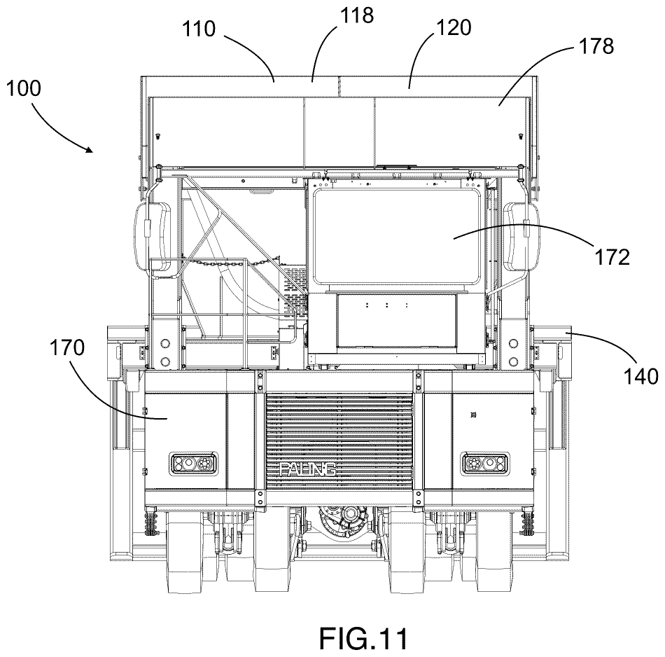

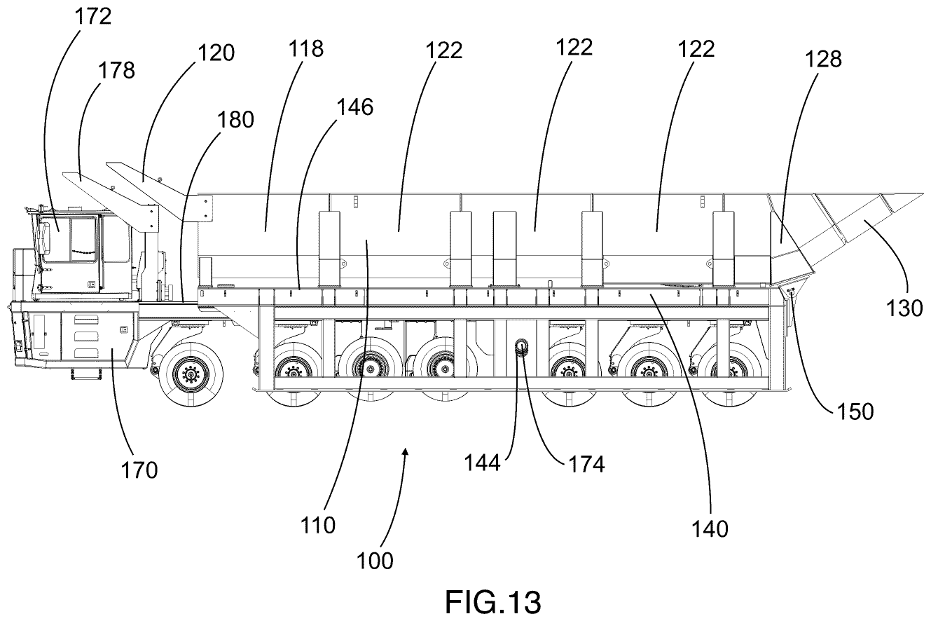

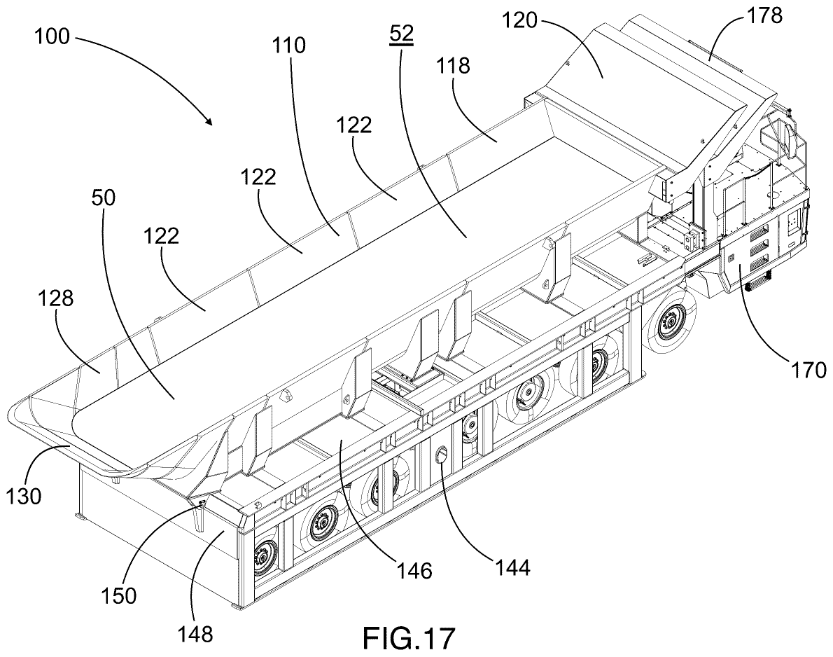

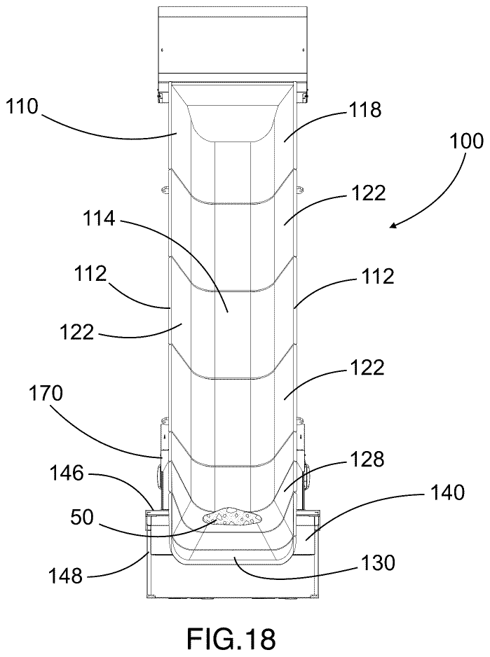

With reference to accompanying FIGS. 1 to 19, there is shown a doorless slag transport device 110,140, system 100, and/or method according to a preferred embodiment of the invention. In FIGS. 1 to 19, the slag transport system 100 is used for the safe and efficient transportation and dumping of slag 50. (As described elsewhere herein, the present invention is also adapted for use in transporting various other materials, including but not limited to coils, scrap, and slabs.)

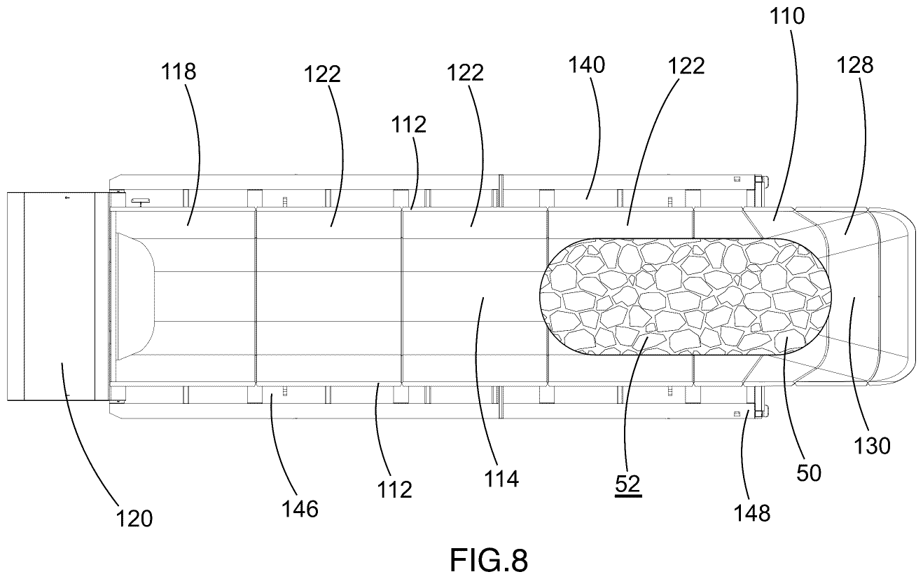

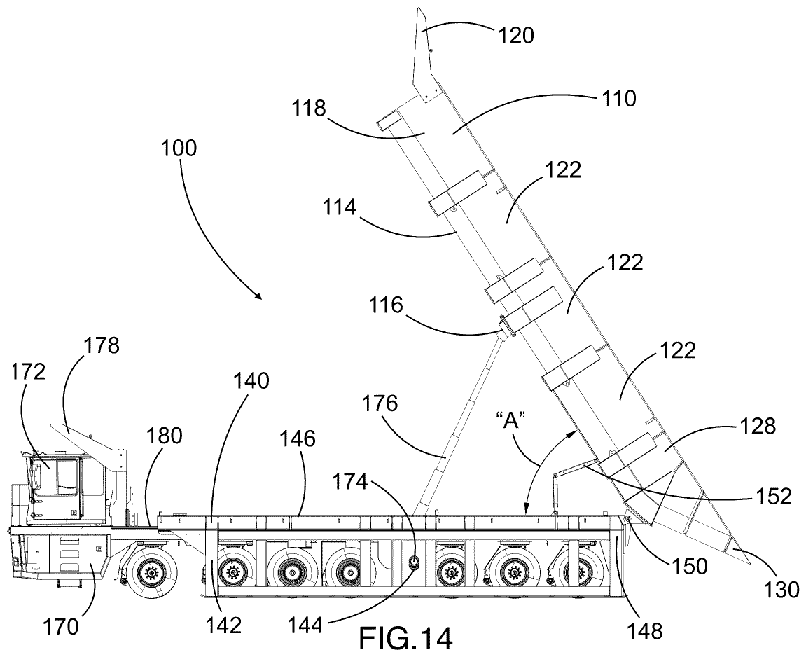

HIGH CAPACITY—OVERVIEW. A dump container 110 of the system 100 was designed with a cross-section that will preferably support the weight of the liquid slag 50, help prevent spillage, create an optimal pouring/dump angle “A” (as best seen in FIG. 14), and/or resist heat transfer to other components in a pallet unit 140 or a transport carrier unit 170. A bottom portion 114 of the dump container 110 is preferably inclined at such an angle (as may be best appreciated from FIG. 8) as to optimize displacement of the slag during pouring into the dump container.

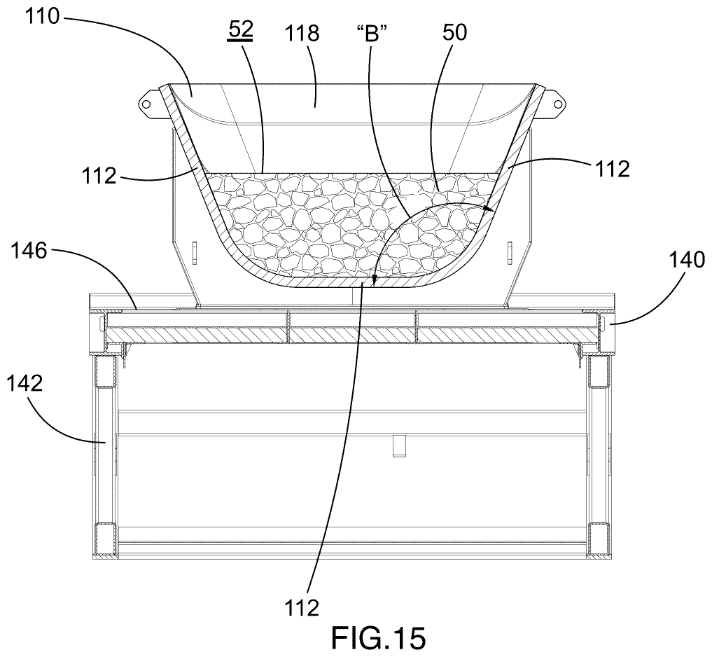

Arm receptacles 116 are preferably located on the bottom 114 of the dump container 110. The telescoping arm 176/arm receptacle 116 configuration is preferably precisely aligned by the transport carrier unit 170 and pallet unit 140 interface during unloading and loading. The dump container 110 cross-section (best seen in FIG. 15) is preferably designed to provide required structural support at high temperatures. Hinge mechanisms 150 between the dump container 110 and the pallet unit 140 are preferably at a back end portion (alternately, herein, the “pallet end portion”) 148 of the pallet unit 140 and at a back end portion (alternately, herein, the “dump end portion”) 128 of the dump container 110.

HIGH CAPACITY—VOLUME VARIATION. The dump container 110 can preferably be sized for all current steel mill furnace slag requirements ranging in volume from about 20 cubic meters to about 70 cubic meters. The dump container's 110 material of construction is preferably a high-strength, fine-grained structural steel. It is preferably thermo-mechanically rolled for high-temperature applications. It is preferably about 80 mm thick special composition steel, with a minimum yield strength which is preferably about 420 MPa (or about 61 ksi).

The dump container 110 is preferably cold-formed and welded to suit specific volume requirements. It is preferably mounted to the pallet unit (alternately, herein, the “base frame”) 140. The base frame 140 is preferably a support structure for the dump container 110. It is preferably connected directly to the dump container 110 at the hinge mechanisms 150 located at the back end portion 148 of the pallet unit 140. The base frame 140 is preferably a weldment constructed of a high-strength steel material.

A standard transport carrier unit 170 (i.e., an elevating engine-driven machine) is preferably about 3.5 meters wide. The length of the carrier unit 170 (and the volume of the dump container 110) can preferably vary based on user needs. Across varying lengths for the dump container 110, its front end portion 118 and back end portion 128 remain substantially the same in terms of their shape.

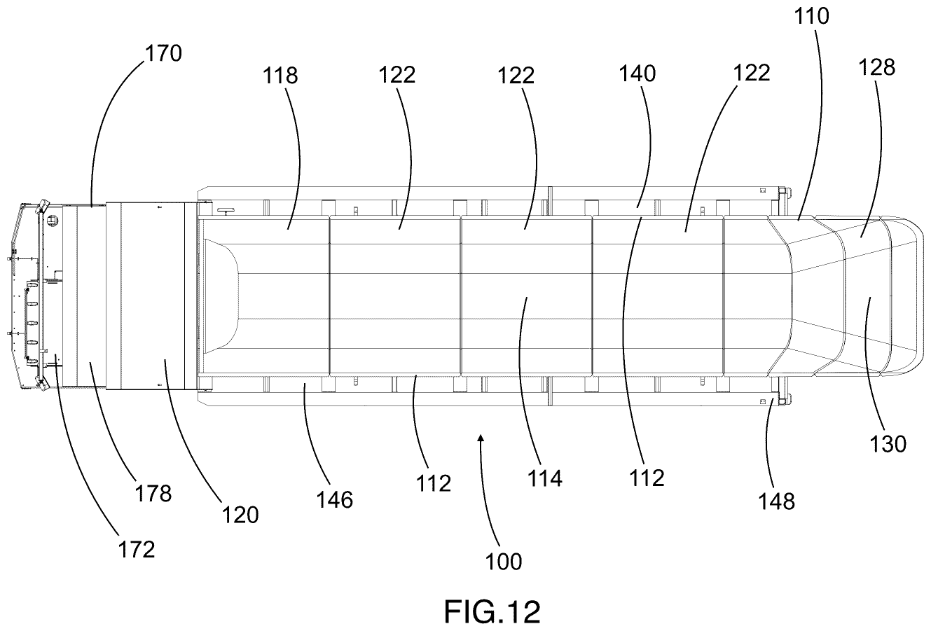

There may be two or more variables in the dump container's 110 design which preferably enable this volume variation. A first variable may be how many mid-sections 122 are added between the two ends 118, 128. (As may be appreciated from FIGS. 12-14 and 18-19, the front end portion 118 and the back end portion 128 preferably remain the same, while a number of mid-sections 122 may vary.) Elongating the container 110 is preferably achieved by keeping the front and back end portions 118, 128 the same and adding more identical mid-sections 122 in the middle. A second variable—which may help increase the volume of the dump container 110—may be to provide the dump container 110 with higher side walls 112. As should be appreciated from a consideration of FIG. 15, the base shape may remain the same, but (with proper support) can be made deeper and made to expand outwards in an open V type configuration.

Load and center of gravity calculations are preferably completed, as necessary, to ensure safe operation.

SLAG PROCESSING. The dump container 110 preferably has a cross-sectional profile (as may be appreciated from a consideration of FIG. 15) that is adapted: to support the weight of a filled load of liquid slag 50; to prevent spillage; to create an optimal pouring/dump angle “A” (as shown in FIG. 14); to resist transfer of heat to other components in the pallet unit 140 and transporter/carrier unit 170; and/or to provide structural support at high temperatures. The bottom 114 of the dump container 110 is preferably inclined at an angle (as may be best appreciated from FIG. 8) adapted to optimize pouring qualities of liquid slag 20 during a dumping cycle.

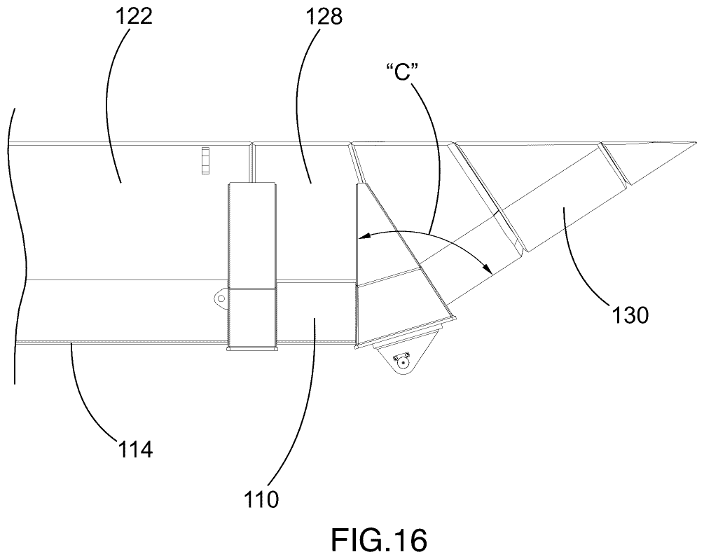

A cross sectional shape (shown in FIG. 16) of the dump container is preferably designed in such a way to enable maximum slag 20 cooling. A side wall angle “B” of about 112 degrees (as shown in FIG. 16) has preferably been engineered to enable such cooling, whilst also maintaining structural strength of the dump container 110 itself.

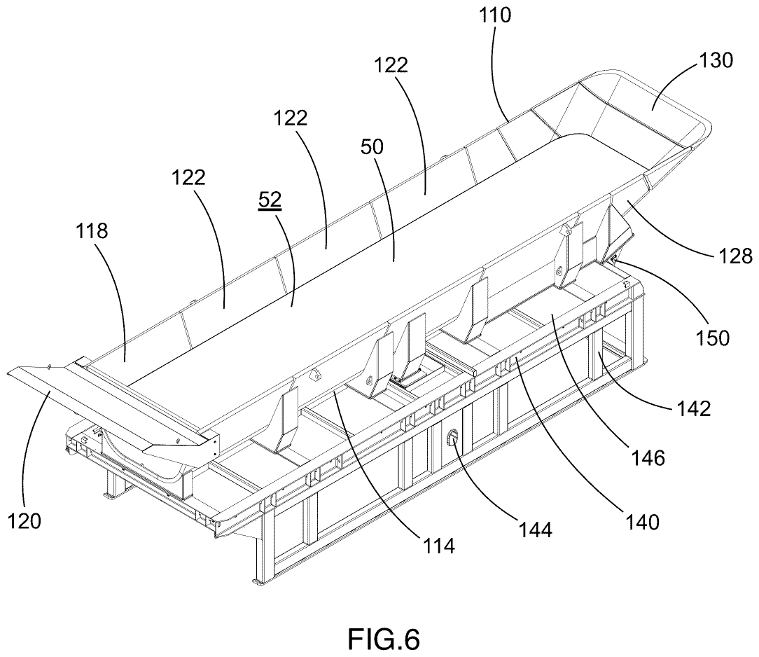

As shown in FIGS. 6, 10, and 17, an elongated vessel type design for the dump container 110 preferably enables cooling of a maximum surface area 52 of hot slag 50. A shallow depth and wide horizontal design preferably enables cooling of the slag 50 in sheet form. According to the invention, this sheet form preferably does not produce a slag skull. A concentration of steel in the slag 50 preferably cannot accumulate into a block, as it previously did in prior art slag pots. This design preferably helps maintain any concentration of solidifying steel as if it were a (fragile) glass sheet.

As perhaps best seen in FIGS. 14, 16, and 18, a spout portion 130 of the dump container 110 is preferably engineered to help center a discharge of slag 50 during dumping. The spout portion 130 preferably enables a controlled discharge of slag material 50. The spout portion 130 has an incline that is designed so that it preferably leaves little or no material 50 in the dump container 110 at a maximum operating dump angle “A” for the container 110, i.e., about 57 degrees (as shown in FIG. 14).

MAINTENANCE/LIFE EXPECTANCY. Dissipation of heat from hot slag 50 is preferably accelerated by the dump container's 110 design—relative to prior art slag pots—because of the available surface area 52 in contact between the hot slag 50 (of about 1200 degrees Celsius) and the surrounding environment (at ambient temperature).

Prior art slag pots may have been adapted to contain about 20 cubic meters of slag. They may have been much closer in shape to a vertical cylinder with a diameter of about 3.127 meters. The surface area of slag exposed directly to ambient temperature in such prior art slag pots may have been about 7.7 square meters.

The dump container 110 according to the invention may preferably afford about the same capacity (i.e., about 20 cubic meters) over a rectangular shape with a width of about 2.951 meters, an effective length of about 10.25 meters, and an exposed surface area 52 of 30.25 square meters. As such, the dump container 110 according to the invention preferably affords about 4 times (e.g., about 3.92 times) as much surface area 52 for cooling the hot slag 50 to ambient temperature—i.e., relative to prior art slag pots.

SAFETY. Prior art container designs may have included both (a) a link serving as a mechanical arm to raise a door on a dump container to enable discharge, with (b) the door driven by hydraulic cylinders for lifting and enabling discharge. According to the invention, the dump container has no mechanical moving parts, or hydraulics required to discharge hot slag into a slag pit.

Prior art dump containers may have been inadequate. Too many mechanical moving parts did not result in a reliably functioning system, and prior art hydraulic door versions may have required hydraulic lines to be run from a carrier (or engine-driven transporter) unit to the pallet unit with the dump container on it. While hydraulics may have helped improve a mechanical link and its functioning as an arm to open the door, the presence of such hydraulics may have created potential complications—e.g., including how best to provide a quick connect apparatus for the hydraulic lines and/or to run stainless steel tubing for the hydraulics down the side of the pallet unit to operate hydraulic cylinders for the door. Sometimes, liquid slag discharged from a furnace can be erratic, with hot slag being sprayed in multiple directions over the side of the container. This erratic discharge may have created safety and/or operational issues with melted hydraulic lines and/or inoperable container doors.

The spout 130 design of the dump container 110 according to the invention helped reduce or eliminate any moving parts that may have previously required hydraulic pressure in the prior art. The design of the dump container 110 and its spout portion 130 helps to retain the full volume of initial liquid slag 50 when it is being discharged from the furnace into the dump container 110, and later to promptly and efficiently discharge the slag 50 from the dump container 110 into the slag pit.

Contours and radiuses of the specialty steel material, from which the spout portion 130 is constructed, have been designed and formed such as to diminish wear that otherwise might be caused by fluid liquid slag 50 during discharge. An even, controlled, and uniform discharge of slag 50 from the dump container 110—as enabled, perhaps at least in part, by the novel shaping of its spout portion 130 as described and depicted elsewhere herein—preferably helps to minimize or reduce wear on the dump container 110 and its materials of construction.

As can be appreciated from FIG. 15, the subject invention's dump container 110 enables more “freeboard”—i.e., a distance from the top of the liquid 50 to the top of the side walls 112 of the container 110—than prior art slag pots. This increased freeboard is preferably an added safety feature. It preferably helps lessen a potential for spillage during transport. Accordingly, the dump container 110 of the present invention affords an increased safety cushion in comparison to prior art slag pots.

The dump container 110 preferably has a canopy portion 120 that extends at its front end portion 118. The canopy portion 120 is preferably adapted to provide an additional measure of splash protection for a cab 172 of the carrier unit 170 and an operator inside (not shown). The transport carrier unit 170 includes a headset component 178 that provides an additional measure of splash protection for the cab 172 and operator.

EXISTING EQUIPMENT. The dump container 110 is preferably suited to fit existing pallet units 140. The dump container 110 is preferably fixed to the pallet unit 140 by way of two hinge mechanisms 150 located at the back end portion 148 or the pallet unit 140 and the back end portion 128 of the dump container 110. The hinges 150 preferably act as hinge points when the dump container 110 is raised by the telescoping cylinders/telescoping arms 176 to dump the load. Safety stops 152 are preferably provided on the end 148 of the pallet unit 140 to help the dump container 110 from being over-extended.

The present invention is adapted for use with palletized methods which enable a single carrier unit 170 (or engine-driven machine) to continually operate. For example, a pallet unit 140 may preferably be transported (dropped off) in place, within a steel plant, to be loaded with new hot-rolled coils of steel. In the meantime, while that pallet unit 140 is being loaded, the carrier unit 170 is free to drive over to another pallet 140 equipped with a full scrap bucket, to pick it up, transport it, and discharge it into a scrap metal pile. After being discharged, the scrap bucket and its pallet 140 can be transported back for loading with more scrap. Then, the carrier unit 170 can return to the first pallet 140 that has since been loaded with the coils of steel and is now ready to transport.

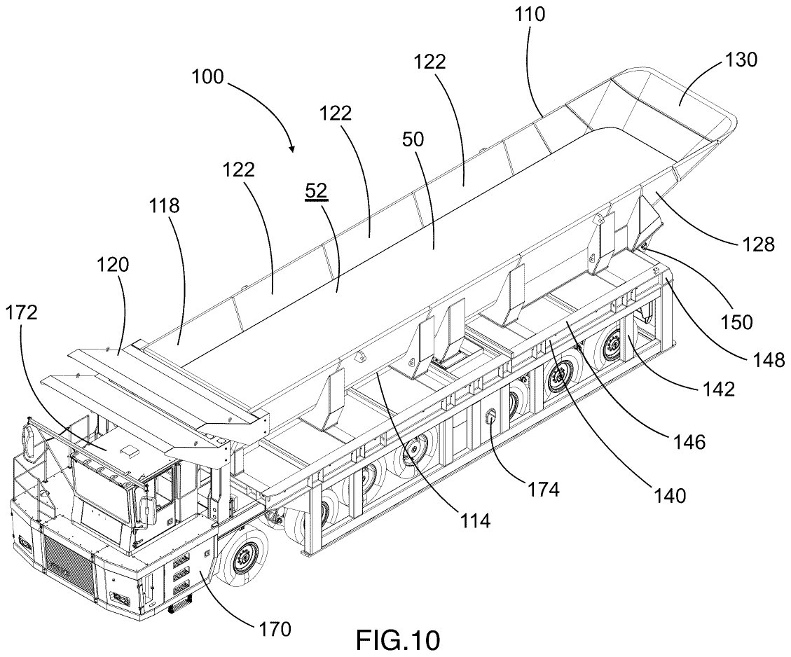

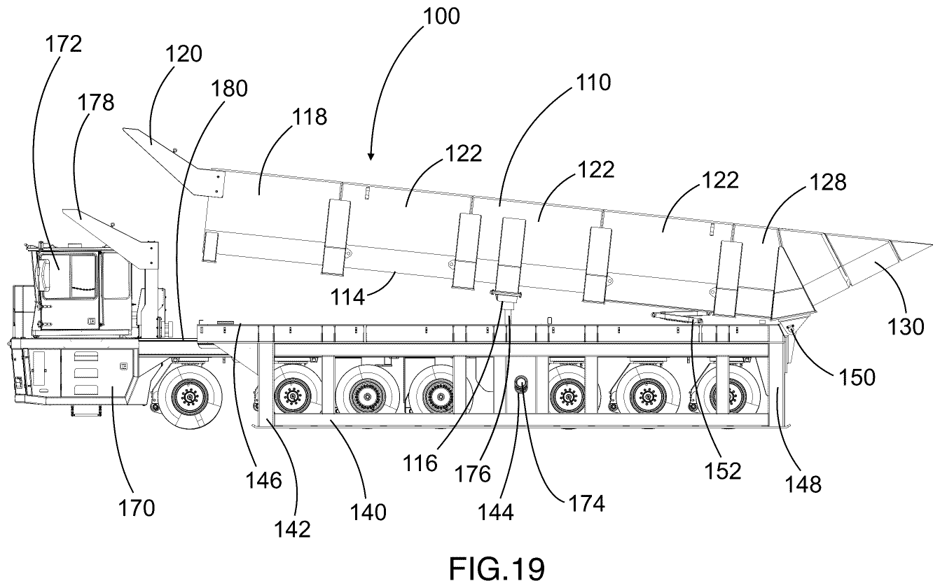

The carrier unit 170 may have its two telescoping cylinders/telescoping arms 176 retracted. FIGS. 10, 13, and 17 shows the carrier unit 170 with a pallet 140 loaded on it with a dump container 110 according to the invention. As best seen in FIGS. 14 and 19, the telescoping cylinders/telescoping arms 176 (preferably male) of the carrier unit 170 preferably engage arm receptacles 116 (preferably female) of the dump container 110 and lift the load, with the container 110 pivoting about the two back hinge points 150, to safely and securely discharge the slag 50. The pallet unit 140 is preferably locked to the carrier unit 170 by way of locking pins 174 which extend horizontally outwards from the carrier unit 170 into pin receptacles 144 of the pallet unit 140 carrying the dump container 110 so that there is preferably little or no chance for the dump container 110 to capsize over the back of the pallet unit 140.

Pallet units 140, in various embodiments of different lengths, may preferably be adapted to work with the same carrier unit 170 to elevate and transport them. In drive mode, the carrier unit 170 preferably backs up under the pallet unit 140, hydraulically elevates its carrier platform 180 (e.g., by about 10-12 inches) to lift the pallet unit 140, which then enables it to transport the pallet unit 140. Conversely, after the carrier unit 170 reaches its destination, it lowers its carrier platform 180, to set the pallet unit 140 on the ground and then drives out from underneath the pallet unit 140.

With prior art slag pots, multiple pieces of equipment may have been required to reach the same final slag state. First, a dedicated slag pot carrier may have been required solely to transport the slag pot to a slag-handling area. In the prior art, a fair amount of slag material may have become stuck to the sides of the slag pots. When this happened, the slag pot carrier may have proceeded to a “knocking” station, where a large crane equipped with a heavy end was used to knock on the edge of the slag pot in an effort to release the stuck material (i.e., skull) from the slag pot. This (large) skull may have then been broken down by thermal lancing—i.e., a prior art process that may have required personnel to cut the material with an oxygen torch. To further break down the skull, a crane equipped with a large heavy ball may have been raised to a maximum height and then released (or dropped) onto the skull material in an attempt to break it up into smaller pieces. Multiple attempts may have frequently been required.

Preferably, the device 110,140, system 100, and method according to the invention, including the dump container 110, may have helped to reduce or eliminate the prior art equipment that was required for primary slag processing and discharging slag 50 into the slag pit in a ready state for secondary processing (e.g., granulation and dispatch of both recyclable steel and non-ferrous material).

FIGS. 1 to 5 depict the engine-driven carrier unit 170 according to the invention. FIGS. 6 to 19 depict the pallet unit 140 and the dump container 110 according to the invention. The pallet unit 140 preferably has a brace frame 142 and a solid top bed 146. The dump container 110 is preferably a wide, shallow, and elongated open-topped vessel. It preferably has a spout portion 130 at its back end portion 128.

The transport/carrier unit 170 may resemble an industrial transport truck. In one embodiment, the transport/carrier unit 170 may preferably be about 4.4 meters tall, about 4.2 meters wide, and about 15.3 meters long from front to back. The transport/carrier unit 170 preferably has a bed/carrier platform 180 behind the cab 172 that preferably is about 12.2 meters long. The carrier platform 180 of the transport unit 170 may preferably have a transport drive height of about 1.91 meters, and can be lowered to about 1.6 meters.

In one embodiment, the pallet unit 140 may preferably be about 3.01 meters wide and about 1.7 meters tall, and the dump container 110 may preferably be about 3.7 meters wide, about 2.7 meters tall, and about 15.6 meters long. In this embodiment, the dump container 110 together with the pallet unit 140 (alternately herein, the “container assembly” or “slag dumping device”) may preferably be about 4.4 meters tall.

The dump container 110 will preferably pivot, about the back end portion 148 of the pallet unit 140, at an angle “A” that ranges from about 45 degrees to about 57 degrees.

RESTATEMENT. As aforesaid, the slag transport system 100 is for use with molten slag 50. It includes the elongate dump container 110, the pallet unit 140, and the transport carrier unit 170.

The dump container 110 receives the molten slag 50. It has a front canopy 120, opposite the dump end portion 128, that protects the cab 172 against splashes of the molten slag 50 for the user (not shown). The dump container 110 includes the inclined container bottom portion 114 and opposing side walls 112. The side walls 112 meet the container bottom portion 114 at a side wall angle of about 112 degrees. The container bottom portion 114 is shaped to define arm receptacles 116. The dump container 110 is shallow, wide, and otherwise adapted to impede formation of a slag skull by the molten slag 50 received within it, and to enable the molten slag 50 to cool in sheet form. The dump container 110 has the dump end portion 128 with its inclined spout portion 130 that is doorless and enables controlled discharge of the molten slag 50 from the dump container 110. The inclined spout portion 130 has a spout angle “C”, relative to the bottom portion, that is about 57 degrees (as shown in FIG. 16). The dump container 110 is constructed from one or more structural steel materials and is about 80 mm thick with a yield strength of at least about 420 MPa. The dump container 110 is configured for heat dissipation such that, when it receives a volume of the molten slag 50 that is substantially about 20 m³, the molten slag 50 has an exposed surface area 52 of about 30 m².

The pallet unit 140 has the pallet end portion 148 with the hinge mechanisms 150 that securely engage the dump end portion 128 and enable pivotal rotation of the dump container 110, about the hinge mechanisms 150, relative to the pallet unit 140. The pallet end portion 148 has safety stops 152 that securely engage the container bottom portion 114 and prevent the dump container 110 from being pivoted beyond the dumping configuration. The pallet unit 140 is shaped to define pin receptacles 144.

The transport carrier unit 170 has a cab 172 for a user (not shown). It also has horizontal locking pins 174 that removably extend into the pin receptacles 144 for secure and detachable locking of the pallet unit 140 to the transport carrier unit 170. (The locking pins 174 are selectively disengageable from the pin receptacles 144 to detach the pallet unit 140 from the transport carrier unit 170.) The transport carrier unit 170 selectively lifts the pallet unit 140 for transport, and selectively lowers the pallet unit 140 for pivoting the dump container 110 about the hinge mechanisms 150. The transport carrier unit 170 has the telescoping arms 176 that securely and detachably engage the arm receptacles 116 of the container bottom portion 114. The telescoping arms 176 are selectively controllable to pivot the dump container 110 about the hinge mechanisms 150, relative to the pallet unit 140, between the transport and dumping configurations.

In the dumping configuration, the dump container 110—free of any door mechanism—discharges the molten slag 50 through the inclined spout portion. The container bottom portion 114 and the inclined spout portion 130 enable substantially complete discharge of the molten slag 50, in sheet form, from the dump container 110. In the dumping configuration, the dump container 110 is raised and pivoted to the dump angle “A”, relative to the pallet unit 140, that is between about 45 and 57 degrees.

The dump container 110 is constructed with a predetermined capacity to receive between about 20 and 70 m³ of the molten slag 50. Its front end portion 118 is opposite the dump end portion 128, and it has mid-sections 122 that are secured between the front end portion 118 and the dump end portion 128. The front end portion 118, the mid-sections 122, and the dump end portion 128 have a cold formed and welded steel construction. The predetermined capacity is selectively adjustable by varying how many of the mid-sections 122 are secured between the front end portion 118 and the dump end portion 128.

In use, the molten slag 50 is received in the dump container 110. And, the telescoping arms 176 of the transport carrier unit 170 are controlled to pivot the dump container 110 about the hinge mechanisms 150, relative to the pallet unit 140, from the transport configuration to the dumping configuration. The dump container 110, free of any door mechanism, then discharges the molten slag 50 through the inclined spout portion 130. In the dumping configuration, the container bottom portion 114 and the inclined spout portion 130 enable substantially complete discharge of the molten slag 50, in sheet form, from the dump container 110.

It may bear repeating that the dump container 110 is constructed with a predetermined capacity for receiving between about 20 and 70 m³ of the molten slag 50. Its front end portion 118 is opposite the dump end portion 128, and mid-sections 122 are secured between the front end portion 118 and the dump end portion 128. The front end portion 118, the mid-sections 122, and/or the dump end portion 128 have a cold formed and welded steel construction. The predetermined capacity is selectively adjustable by varying how many of the mid-sections 122 are secured between the front end portion 118 and the dump end portion 128.

Preferably, the invention helps provide one or more advantages over the prior art—and/or helps to solve, obviate, and/or mitigate one or more problems associated with the prior art—including (but not limited to) those described below and/or elsewhere herein. The invention preferably provides one or more advantages over the prior art, as follow: (a) the dump container 110 is constructed from a special high-strength, heat-resistant steel which preferably provides a longer life-expectancy than prior art slag pots. (b) Steel plants change their processes from time-to-time and their required slag movements. An increase in slag volume produced by a steel plant may require a new higher capacity slag pot and a new power unit. The present invention affords the steel producer with flexibility and enables only the container 110 to be replaced while still using the same pallet unit 140 and the same transporter/carrier unit 170. (c) A flexible capacity of the dump container 110 according to the present invention may afford customers with a wide range of container volumes under different footprints, enabling the invention to be used in new and old facilities. (d) Slag 50 produced by steel plants is typically processed to recover steel and other minerals therefrom. Processing slag 50 using the device 110,140, system 100, and method according to the invention is financially advantageous, helps to reduce or eliminate a labor-intensive step—perhaps the most labor-intensive step—in processing slag 50, helps to reduce or eliminate creation and processing of skulls, and/or helps to minimize the environmental impact of slag 50 processing. (e) The dump container 110 and the angle “C” of its spout portion 130 (as perhaps best seen in FIG. 16) preferably helps to reduce or eliminate a requirement for hydraulic actuators and/or risk of fire, in comparison to the prior art. And/or, (f) the present invention helps to reduce or eliminate a requirement for lancing and/or mechanical cracking operations, which may have been environmentally unfriendly.

The invention is contemplated for use by or in association with slag 50 and other metallurgic by-product transportation and dumping, as stated above. The invention, however, is not so limited. And, in any event, other embodiments which fall within the scope of the invention may be provided.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations and/or steps according to the invention are not specifically referenced in association with one another, they may be used, and/or adapted for use, in association therewith. All the aforementioned and various other structures, configurations, relationships, utilities, any which may be depicted and/or based hereon, and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims hereof.

1. A doorless slag transport system, for use with molten slag in the steel industry, comprising:
(a) an elongate dump container, adapted to receive the molten slag, having a container bottom portion and a dump end portion with an inclined spout portion that is doorless and enables controlled discharge of the molten slag from the dump container;
(b) a pallet unit having a pallet end portion with one or more hinge mechanisms that securely engage the dump end portion and enable pivotal rotation of the dump container, about the hinge mechanisms, relative to the pallet unit; and
(c) a transport carrier unit securely and detachably engaging the pallet unit; wherein the transport carrier unit has one or more telescoping arms that securely and detachably engage the container bottom portion;
wherein the telescoping arms are selectively controllable to pivot the dump container about the hinge mechanisms, relative to the pallet unit, between a transport configuration and a dumping configuration whereat the dump container, free of any door mechanism, discharges the molten slag through the inclined spout portion.

2. A doorless slag transport system according to claim 1, wherein the dump container is shallow, wide, and otherwise adapted to impede formation of a slag skull by the molten slag received therewithin, and to enable the molten slag to cool in sheet form; wherein the container bottom portion is inclined; and, in the dumping configuration, the container bottom portion and the inclined spout portion enable substantially complete discharge of the molten slag, in said sheet form, from the dump container.

3. A doorless slag transport system according to claim 1, wherein the inclined spout portion has a spout angle, relative to the bottom portion, that is substantially about 57 degrees.

4. A doorless slag transport system according to claim 1 wherein, in the dumping configuration, the dump container is raised and pivoted to a dump angle, relative to the pallet unit, that is substantially between about 45 and 57 degrees.

5. A doorless slag transport system according to claim 1, wherein the pallet end portion has one or more safety stops that securely engage the container bottom portion and prevent the dump container from being pivoted beyond the dumping configuration.

6. A doorless slag transport system according to claim 1, wherein the dump container is constructed from one or more structural steel materials, and is substantially about 80 mm thick with a yield strength of at least about 420 MPa.

7. A doorless slag transport system according to claim 1, wherein the dump container is configured for heat dissipation such that, when the dump container receives a volume of the molten slag that is about 20 m³, the molten slag has an exposed surface area of substantially about 30 m².

8. A doorless slag transport system according to claim 1, wherein the dump container has opposing side walls, and each of the side walls meets the container bottom portion at a side wall angle of about 112 degrees.

9. A doorless slag transport system according to claim 1, wherein the container bottom portion is shaped to define one or more arm receptacles; and wherein the telescoping arms securely and detachably engage the arm receptacles.

10. A doorless slag transport system according to claim 1, wherein the pallet unit is shaped to define pin receptacles, and the transport carrier unit has horizontal locking pins that removably extend into the pin receptacles for secure locking of the pallet unit to the transport carrier unit; and wherein the horizontal locking pins are selectively disengageable from the pin receptacles to detach the pallet unit from the transport carrier unit.

11. A doorless slag transport system according to claim 1, wherein the dump container is constructed with a predetermined capacity to receive between about 20 and 70 m³ of the molten slag.

12. A doorless slag transport system according to claim 11, wherein the dump container has a front end portion opposite the dump end portion, and one or more mid-sections that are secured between the front end portion and the dump end portion; wherein the front end portion, the mid-sections, and the dump end portion have a cold formed and welded steel construction; and wherein the predetermined capacity is selectively adjustable by varying how many of the mid-sections are secured between the front end portion and the dump end portion.

13. A doorless slag transport system according to claim 1, wherein the transport carrier unit selectively lifts the pallet unit for transport, and selectively lowers the pallet unit for pivoting the dump container about the hinge mechanisms.

14. A doorless slag transport system according to claim 1, wherein the transport carrier unit has a cab for a user, and the dump container has a front canopy, opposite the dump end portion, that protects the cab against splashes of the molten slag for the user.

15. A doorless slag dumping device, for use with molten slag and a transport carrier unit having one or more telescoping arms, comprising:
(a) an elongate dump container, adapted to receive the molten slag, having a container bottom portion and a dump end portion with an inclined spout portion that is doorless and enables controlled discharge of the molten slag from the dump container; wherein the telescoping arms securely and detachably engage the container bottom portion; and
(b) a pallet unit, for secure and detachable engagement with the transport carrier unit, having a pallet end portion with one or more hinge mechanisms that securely engage the dump end portion and enable pivotal rotation of the dump container, about the hinge mechanisms, relative to the pallet unit;
wherein the telescoping arms are selectively controllable to pivot the dump container about the hinge mechanisms, relative to the pallet unit, between a transport configuration and a dumping configuration whereat the dump container, free of any door mechanism, discharges the molten slag through the inclined spout portion.

16. A method, for use with the system of claim 1, comprising the steps of:
(a) receiving molten slag in the dump container; and
(b) controlling the telescoping arms of the transport carrier unit to pivot the dump container about the hinge mechanisms, relative to the pallet unit, from the transport configuration to the dumping configuration, such that the dump container, free of any door mechanism, discharges the molten slag through the inclined spout portion.

17. A method according to claim 16 wherein, in step (a), the dump container is shallow and wide and impedes formation of a slag skull by the molten slag received therewithin, the container bottom portion is inclined and enables the molten slag to cool in sheet form; and in step (b), in the dumping configuration, the container bottom portion and the inclined spout portion enable substantially complete discharge of the molten slag, in said sheet form, from the dump container.

18. A method according to claim 16, wherein, in step (b), the dump container is raised and pivoted to a dump angle, relative to the pallet unit, that is substantially between about 45 and 57 degrees.

19. A method according to claim 16, further comprising use of the transport carrier unit to selectively lift the pallet unit for transport, and selectively lower the pallet unit for pivoting the dump container about the hinge mechanisms.

20. A method according to claim 16, further comprising a step, before step (a), of constructing the dump container with a predetermined capacity for receiving between about 20 and 70 m³ of the molten slag, with a front end portion opposite the dump end portion, and with one or more mid-sections secured between the front end portion and the dump end portion; wherein the front end portion, the mid-sections, and the dump end portion have a cold formed and welded steel construction; and wherein the predetermined capacity is selectively adjustable by varying how many of the mid-sections are secured between the front end portion and the dump end portion.
